(19) United States
(12) Patent Application Publication
(10) Pub. No.: US 2008/0168449 A1
(43) Pub. Date: Jul. 10, 2008

(54) Method and system for associating metadata with content

(75) Inventors: Kevin Rice, Altadena, CA (US); Armando Santana, Glendale, CA (US); Shelley Short, Pasadena, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: Disney Enterprises, Inc.

(21) Appl. No.: 11/652,252

(22) Filed: Jan. 10, 2007

(51) Int. Cl. G06F 9/44; G06F 17/30

(52) U.S. Cl. 718/102; 707/102; 707/E17.044

(57) ABSTRACT

There is provided a method for associating metadata with content. According to one embodiment, the content is created for a scheduled event, where the metadata includes at least one metadata tag correlated to an event time period of the scheduled event. The method includes receiving content having a known time period. For example, the content can be a digital image, a video, or other data and the known time period can be a time period at which the content was created. The method further includes matching the known time period of the content with the event time period and determining the at least one metadata tag correlated to the event time period. The method further includes associating the at least one metadata tag with the content.

### BACKGROUND OF THE INVENTION

1. Field of the Invention

The present invention relates generally to content management. More particularly, the present invention relates to techniques for efficient management of content.

2. Background Art

Today's handheld electronic devices are capable of capturing and storing large amounts of content. For example, interchangeable memory devices, such as memory cards, enable many digital cameras to capture and store thousands of photographs with relative ease. Such handheld electronic devices, however, typically fail to provide tools for efficient management of content, making the identification and sorting of large amounts of content extremely difficult.

One known method used to manage content involves the use of computer software which allows a user to view content and to manually enter information or “metadata tags” describing each content into free-form text entry fields. For example, a user may manually enter metadata associated with a digital photograph by entering text that describes the subject matter of the photograph, the location where the photograph was taken, and the quality of the photograph. Content associated with such metadata can then be efficiently identified by direct references to the metadata. However, the known method discussed above suffers significant drawbacks. For example, since the user of the computer software must manually enter the metadata associated with each content by typing in text, the manual entry of metadata for large amounts of content using the known method can be very time consuming and inconvenient.

Another known method used to manage content involves the use of a data entry device, such as a keypad, which can be included on a handheld electronic device. For example, handheld electronic devices such as cellular telephones with built in cameras typically include a keypad which can be used to manually enter text, thereby allowing a user to enter metadata for content. Other handheld electric devices such as digital cameras, can provide an “on-screen” keypad displayed on a liquid crystal display (“LCD”) interface, which can be also be used to manually enter metadata for content by selecting letters and characters shown on the on-screen keypad. However, given the typical compact size of such handheld electronic devices, the abovementioned keypads tend to be very small and consequently difficult to use. For example, if a user captures over one thousand photographs with a digital camera, the user is required to enter metadata letter by letter for each photograph. Moreover, such use of keypads require a user to create custom metadata information, e.g., metadata tags, for each and every content, making the process of entering metadata very inefficient.

Accordingly, there is a need in the art for methods and systems which provide efficient and convenient association of metadata with content.

### SUMMARY OF THE INVENTION

There is provided methods and systems for associating metadata with content, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates a system for associating metadata with content, in accordance with one embodiment of the present invention;

FIG. 2 illustrates a flow diagram of a method for associating metadata with content, in accordance with one embodiment of the invention;

FIG. 3 illustrates a system for associating metadata with content, in accordance with one embodiment of the present invention; and

FIG. 4 illustrates a flow diagram of a method for associating metadata with content, in accordance with one embodiment of the invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

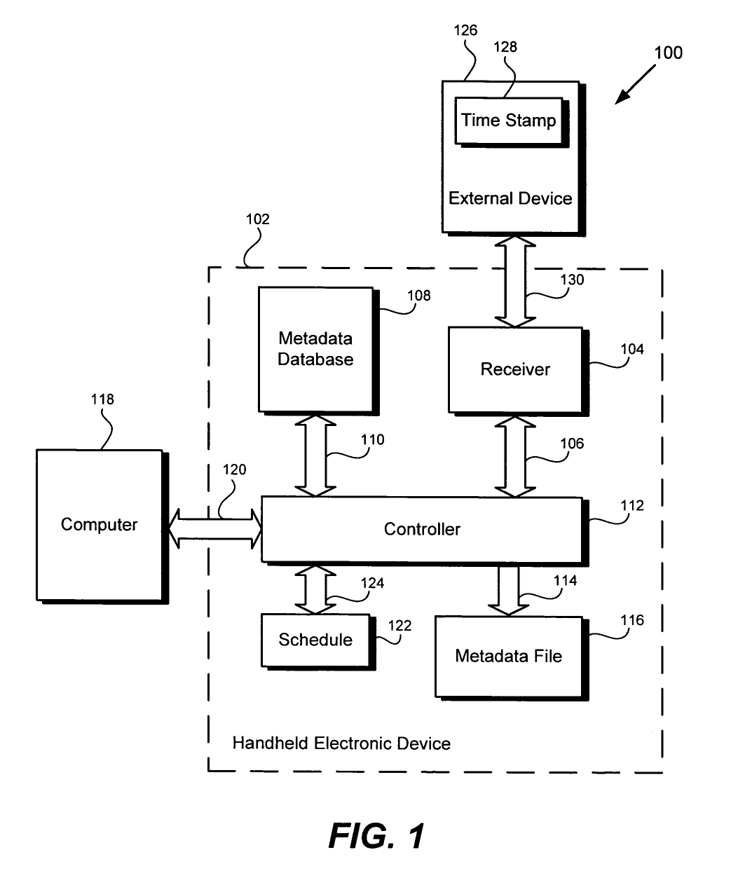

FIG. 1 illustrates a block diagram of a system for associating metadata with content, in accordance with one embodiment of the present invention. As shown in FIG. 1, system 100 includes handheld electronic device 102, computer 118, and external device 126. As also shown in FIG. 1, handheld electronic device 102 includes receiver 104, metadata database 108, and controller 112. For example, handheld electronic device 102 and external device 126 can each be one of a digital camera, a cellular telephone, or a personal digital assistant (“PDA”).

As shown in FIG. 1, receiver 104 and metadata database 108 are in communication with controller 112 via respective data paths 106 and 110. Receiver 104, for example, can be a memory device capable of receiving and storing content. For example, metadata database 108 can be a memory device capable of storing metadata and controller 112 can be microcontroller. Computer 118 shown in FIG. 1 is in communication with controller 112 via datapath 120. For example, computer 118 can be a personal computer or other suitable computer.

Computer 118 in FIG. 1 can be used to create or receive a schedule, such as schedule 122 in handheld electronic device 102, which includes a number of scheduled events where each event has a corresponding event time period. The schedule can be, for example, an itinerary of events for people visiting a theme park or an itinerary of events for tourists visiting various destinations. For example, an event can include visiting an attraction, watching a show, or having dinner with family. Moreover, each event can have a corresponding event time period. For example, the visiting an attraction event can have an event time period of 1:00 p.m. to 2:00 p.m. while the dinner with family event can have an event time period of 6:00 p.m. to 7:00 p.m. In the embodiment shown in FIG. 1, schedule 122 is stored in handheld electronic device 102 such that schedule 122 can be accessed by controller 112 via data path 124. In other embodiments, schedule 122 can be stored in computer 118.

Schedule 122 in FIG. 1 can be used by computer 118 to build a metadata database, such as metadata database 108 in FIG. 1, by creating at least one metadata tag that includes descriptive information about an event in schedule 122 and correlating the metadata tag to the event time period of that event. The metadata tag can be defined as, among other things, a name of an activity, a name of a location, or other details related to an event included in schedule 122. For example, a metadata tag for the dinner with family event can be defined as “dinner with family” and can be correlated to an event time period of “6:00 p.m. to 7:00 p.m.” as included in schedule 122. The metadata tag, along with the correlated event time period, can then be communicated to controller 112 in handheld electronic device 102 and stored in metadata database 108 via data path 110. Thus, in one embodiment of the invention, metadata database 108 can include a number of metadata tags describing all of the scheduled events in schedule 122.

Receiver 104 in FIG. 1 can be configured to receive content created for an event in schedule 122, where the content has a known time period. For example, the content can include an image, a video, or other data. If the handheld electronic device is a digital camera, for example, the content can be a digital photograph. The known time period of the content, for example, can be the time period at which the content was created. Thus, if the content is a digital photograph taken at 6:30 p.m. of a family having dinner, the known time period of the content would be “6:30 p.m.” By way of background, handheld electronic devices, such as digital cameras, can typically embed time information, e.g., a time stamp, in content indicating when the content was created. In one embodiment, the known time period of the content can be the abovementioned time information embedded in the content. For example, external device 126 can be configured to embed time stamp 128 in the content and to provide the content to receiver 104 via datapath 130. In another embodiment, the known time period of the content can reside outside the content, such as in a separate file or database.

Controller 112 shown in FIG. 1 can be configured to match the known time period of the content with an event time period correlated to a metadata tag in metadata database 108. For example, the known time period of “6:30 p.m.” of the content including a digital photograph taken at 6:30 p.m. of a family having dinner discussed above can be matched by controller 112 to the event time period of “6:00 p.m. to 7:00 p.m.” in metadata database 108, since the known time period of “6:30 p.m.” is included in the event time period of “6:00 p.m. to 7:00 p.m.” Controller 112 can be configured to then determine the metadata tag correlated to the event time period of “6:00 p.m. to 7:00 p.m.” in metadata database 108, which in this example would be the metadata tag defined as “dinner with family.” Thereafter, controller 112 can associate the metadata tag defined as “dinner with family” in metadata database 108 with the content including a digital photograph of a family having dinner to aptly describe the content. In one embodiment, controller 112 can also be configured to generate a metadata file, such as metadata file 116 in FIG. 1 via data path 114, which associates the at least one metadata tag with the content.

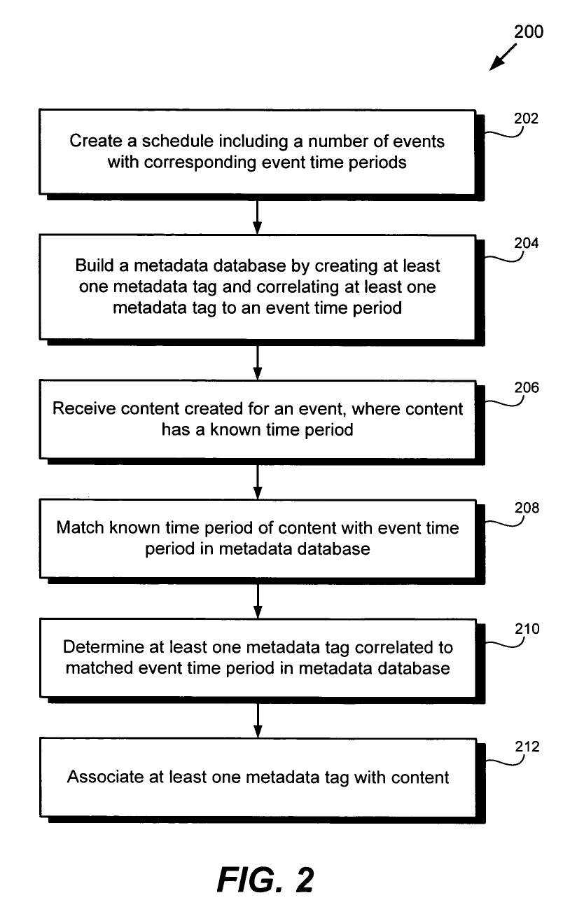

FIG. 2 illustrates a flow diagram of a method for associating metadata with content, in accordance with one embodiment of the invention. With reference to FIG. 1 and as shown in FIG. 2, at step 202 of flowchart 200, a schedule, e.g., schedule 122 in FIG. 1, including a number of events with corresponding event time periods is created using computer 118. The schedule can be, for example, an itinerary of events for people visiting a theme park or an itinerary of events for tourists visiting various destinations.

At step 204 of flowchart 200, a metadata database is built by creating at least one metadata tag and correlating the metadata tag to an event time period in the schedule. For example, the metadata tag can be created by computer 118 and stored, along with the correlated event time period, in metadata database 108. Thus, the metadata tag can include descriptive information about an event in schedule 122 and can be correlated to the event time period of that event. For example, the metadata tag can be defined as, among other things, a name of an activity, a name of a location, or other details related to an event included in schedule 122.

At step 206 of flowchart 200, content created for an event in the schedule is received, where the content has a known time period. For example, the content can include an image, a video, or other data. If the handheld electronic device is a digital camera, for example, the content received can be a digital photograph. The known time period of the content, for example, can be the time at which the content was created. Thus, if the content is a digital photograph taken at 6:30 p.m. of a family having dinner, the known time period of the content would be “6:30 p.m.” In one embodiment, the known time period of the content can be the abovementioned time information embedded in the content. In another embodiment, the known time period of the content can reside outside the content, such as in a separate file or database.

At step 208 of flowchart 200, the known time period of the content is matched with an event time period in metadata database 108. For example, the known time period of “6:30 p.m.” of the content including a digital photograph taken at 6:30 p.m. of a family having dinner discussed above can be matched by controller 112 to the event time period of “6:00 p.m. to 7:00 p.m.” in metadata database 108, since the known time period of “6:30 p.m.” is included in the event time period of “6:00 p.m. to 7:00 p.m.”

At step 210 of flowchart 200, the metadata tag correlated to the matched event time period in metadata database 108 is determined. For example, for the matched event time period of “6:00 p.m. to 7:00 p.m.” discussed above, controller 112 can be used to determine the metadata tag correlated to the event time period of “6:00 p.m. to 7:00 p.m.” in metadata database 108, which in this example would be the metadata tag defined as “dinner with family.”

Thereafter, at step 212 of flowchart 200, the metadata tag is associated with the content. For example, controller 112 can be used to associate the metadata tag defined as “dinner with family” in metadata database 108 with the content including a digital photograph of a family having dinner to aptly describe the content. In one embodiment, controller 112 can also be configured to generate a metadata file, such as metadata file 116 in FIG. 1 via data path 114, which associates the metadata tag with the content.

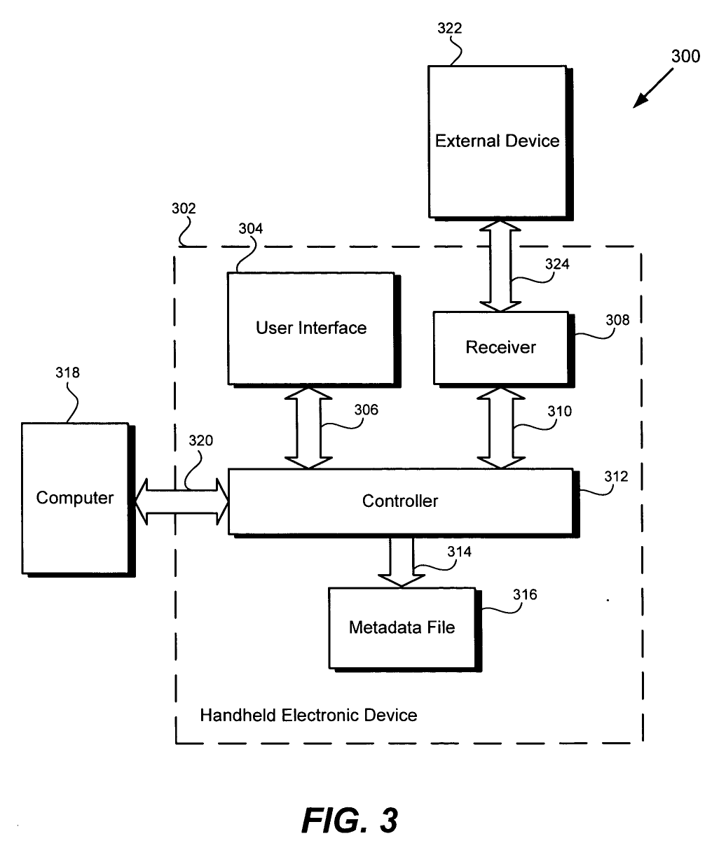

FIG. 3 illustrates a system for associating metadata with content in accordance with one embodiment of the present invention. As shown in FIG. 3, system 300 includes handheld electronic device 302, computer 318, and external device 322. As also shown in FIG. 3, handheld electronic device 302 includes user interface 304, receiver 308, and controller 312. For example, handheld electronic device 302 and external device 322 can each be one of a digital camera, a cellular telephone, or a personal digital assistant (“PDA”).

As shown in FIG. 3, user interface 304 and receiver 308 are in communication with controller 312 via respective data paths 306 and 310. User interface 304, for example, can be a liquid crystal display (“LCD”) which can be used by a user to interact with handheld electronic device 302. Receiver 308, for example, can be a memory device capable of receiving and storing content. For example, external device 322 can provide content to receiver 308 via data path 324. Controller 312, for example, can be microcontroller. Computer 318 shown in FIG. 3 is in communication with controller 312 via datapath 320. For example, computer 318 can be a personal computer or other suitable computer.

Computer 318 in FIG. 3 can be used to create one or more predefined metadata tags for handheld electronic device 304. The predefined metadata tags can include various information used to describe content received in handheld electronic device 302, such as a name of a person, a name of a location, or an activity. The predefined metadata tags can also include information regarding the quality of the content, such as information indicating whether the content has a high quality or a low quality. In one embodiment, the predefined metadata tags can be created by the user via the user interface included on a handheld electronic device. For example, a user may create one predefined metadata tag defined as “family” and another predefined metadata tag defined as “friends.”

Computer 318 in FIG. 3 can be configured to load the predefined metadata tags into handheld electronic device 302 by providing the predefined metadata tags to controller 312 via data path 320. Controller 312 can be configured to provide the predefined metadata tags to user interface 304 via data path 306, thereby allowing user interface 304 to display the predefined metadata tags. Receiver 308 shown in FIG. 3 can be configured to receive content created by handheld electronic device 302. In one embodiment, the content can be created in another handheld electronic device and provided to receiver 308. For example, the content can include an image, a video, or other data. If the handheld electronic device is a digital camera, for example, the content can be a digital photograph.

User interface 304 in FIG. 3 can be configured to present a user with the predefined metadata tags and can be configured to request a user to select one or more of the metadata tags for the content received. For example, if the handheld electronic device is a digital camera and the content received is a digital photograph of the user's friends, the user might prefer to select the predefined metadata tag defined as “friends” to aptly describe the content received. Accordingly, if the content received is a digital photograph of the user's family, the user might prefer to select the predefined metadata tag defined as “family.” In one embodiment of the invention, the user might be asked to select a predefined metadata tag even before the content is received, thereby allowing the user to anticipate the subject matter of the content to be received.

Controller 312 can be further configured to associate the predefined metadata tags selected by the user with the content. In one embodiment, the one or more predefined metadata tags selected by the user can be embedded in the received content by controller 312. In another embodiment, controller 312 can be configured to generate a separate file, such as metadata file 316, which includes the association between the predefined metadata tags selected by the user and the content. Thus, once the predefined metadata tags are associated with the received content, the content can be identified by referencing the predefined metadata tags selected by the user to facilitate identification and management of the content. The invention, therefore, allows efficient and convenient entry of metadata information for content, without requiring the user to repetitively enter text each time content is received.

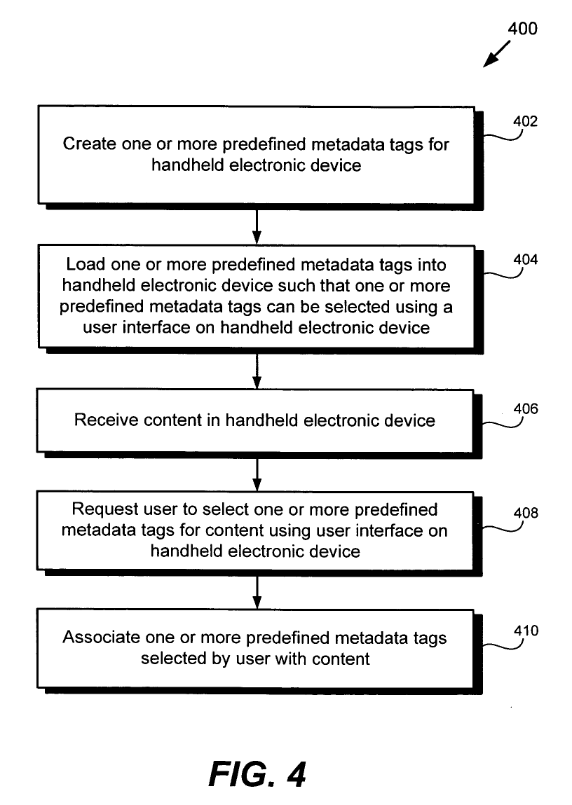

FIG. 4 illustrates a flow diagram of a method for associating metadata with content in accordance with one embodiment of the invention. With reference to FIG. 3 and as shown in FIG. 4, at step 402 of flowchart 400, one or more predefined metadata tags are created for handheld electronic device 302. For example, the predefined metadata tags can be created using computer 318 shown in FIG. 3. The predefined metadata tags can include various information used to describe content received in handheld electronic device 302, such as a name of a person, a name of a location, or an activity. The one or more predefined metadata tags can also include information regarding the quality of the content, such as information indicating whether the content has a high quality or a low quality. In one embodiment, the predefined metadata tags can be created by the user via the user interface included on a handheld electronic device.

As shown in FIG. 4, at step 404 of flowchart 400, the one or more predefined metadata tags created at step 402 are loaded into handheld electronic device 302 such that the predefined metadata tags can be selected using user interface 304 on handheld electronic device 302. For example, the predefined metadata tags can be provided to controller 312 via datapath 320 and further provided to user interface 304 via data path 306, thereby allowing user interface 304 to display the predefined metadata tags. As shown in FIG. 4, at step 406 of flowchart 400, content is received in handheld electronic device 406. For example, the content can include an image, a video, or other data. The content can be received, for example, by receiver 308 shown in FIG. 3. In one embodiment, the content can be created in another handheld electronic device and provided to receiver 308.

At step 408 of flowchart 400, a user is requested to select one or more predefined metadata tags for the content using user interface 304 on handheld electronic device 302. The one or more predefined metadata tags can include various information used to describe the content received, such as a name of a person, a name of a location, or an activity. Thus, after content is received at step 406, the user can manually select one or more of the predefined metadata tags using user interface 304. For example, if the handheld electronic device is a digital camera and the content received is a digital photograph of the user's friends, the user might prefer to select the predefined metadata tag defined as “friends” to aptly describe the content received. Accordingly, if the content received is a digital photograph of the user's family, the user might prefer to select the predefined metadata tag defined as “family.” In one embodiment of the invention, the user might be asked to select a predefined metadata tag even before the content is received, thereby allowing the user to anticipate the subject matter of the content to be received.

As shown in FIG. 4, at step 410 of flowchart 400, the one or more predefined metadata tags selected by the user are associated with the content. In one embodiment, the one or more predefined metadata tags selected by the user are embedded in the received content. In another embodiment, the association between the one or more predefined metadata tags and the content is stored in a separate file or database. Thus, once the one or more predefined metadata tags are associated with the received content, the content received at step 406 can be identified by referencing the one or more predefined metadata tags selected by the user at step 408 to facilitate identification and management of the content.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for associating metadata with content, said content being created for a scheduled event, wherein said metadata comprises at least one metadata tag correlated to an event time period of said scheduled event, said method comprising:
receiving said content, wherein said content has a known time period;
matching said known time period of said content to said event time period;
determining said at least one metadata tag correlated to said event time period;
associating said at least one metadata tag with said content.

2. The method of claim 1 wherein said content comprises a digital photograph.

3. The method of claim 1 wherein said at least one metadata tag comprises information selected from a group consisting of a name of a location, a name of an event, or a name of an activity.

4. The method of claim 1 further comprising creating a schedule prior to receiving said content, wherein said schedule includes at least one said scheduled event, wherein said schedule is an itinerary of events for people visiting a theme park.

5. The method of claim 1 further comprising creating a metadata database prior to receiving said content, wherein said metadata database includes said at least one metadata tag correlated to said event time period of said scheduled event.

6. The method of claim 1 wherein said known time period is a time period at which said content was created.

7. The method of claim 1 further comprising storing an association between said at least one metadata tag and said content in a file.

8. A system for associating metadata with content, said content being created for a scheduled event, wherein said metadata comprises at least one metadata tag correlated to an event time period of said scheduled event, said system comprising:
a receiver configured to receive said content having a known time period;
a metadata database configured to store said at least one metadata tag and said event time period correlated to said at least one metadata tag;
a controller configured to match said known time period of said content to said event time period and associating said at least one metadata tag correlated to said event time period with said content.

9. The system of claim 8 wherein said content comprises a digital photograph.

10. The system of claim 8 wherein said at least one metadata tag comprises information selected from a group consisting of a name of a location, a name of an event, or a name of an activity.

11. The system of claim 8 wherein said known time period is a time period at which said content was created.

12. The system of claim 8 wherein said controller generates a file associating said at least one metadata tag with said content.

13. A method for use by a handheld electronic device for facilitating the association of metadata with content, said handheld electronic device having a user interface, said method comprising:
creating one or more predefined metadata tags;
receiving said content in said handheld electronic device;
requesting a user to select said one or more predefined metadata tags using said user interface; and
associating said one or more predefined metadata tags selected by said user with said content.

14. The method of claim 13 wherein said content comprises a digital photograph.

15. The method of claim 13 wherein said one or more predefined metadata tags comprise information selected from a group consisting of a name of a person, a name of a location, or a name of an activity.

16. The method of claim 13 wherein said one or more predefined metadata tags are created by said user.

17. The method of claim 13 wherein said handheld electronic device is a digital camera.

18. The method of claim 13 further comprising loading said one or more predefined metadata tags into said handheld electronic device using a computer prior to receiving said content.

19. The method of claim 13 further comprising storing an association between said at least one metadata tag and said content in a file.

20. The method of claim 13 wherein said one or more predefined metadata tags comprise information about a quality of said content.
